(19) United States
(12) Patent Application Publication
(10) Pub. No.: US 2010/0138397 A1
(43) Pub. Date: Jun. 3, 2010

(54) SYSTEM AND METHOD FOR PROVIDING E-BOOK

(75) Inventors: Li LI, SHANGHAI CITY (CN); Liang HUANG, SHANGHAI CITY (CN); Shih-Kuang TSAI, SHANGHAI CITY (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/621,521

(22) Filed: Nov. 19, 2009

(30) Foreign Application Priority Data
Nov. 28, 2008 (TW) 97146360

(51) Int. Cl. G06F 17/30; G06K 9/00

(52) U.S. Cl. 707/687; 382/162; 707/E17.006

(57) ABSTRACT

A system for providing at least one electronic book is disclosed. The system can adjust the format of the electronic book in accordance with the specification of the reader and thereby make the electronic book compatible with the reader. Moreover, a method for providing at least one electronic book is also disclosed in specification.

### RELATED APPLICATIONS

This application claims priority to Taiwan Application Serial Number 97146360, filed Nov. 28, 2008, which is herein incorporated by reference.

### BACKGROUND

1. Field of Invention

The present invention relates to a server and an operating method thereof. More particularly, the present invention relates to a system and a method for providing an electronic book.

2. Description of Related Art

An e-book (short for electronic book) is the digital media equivalent of a conventional printed book. Such documents are usually read on personal computers, or on dedicated hardware devices known as e-book readers or e-book devices. Many mobile phones can also be used to read e-books.

With Internet access becoming ubiquitous in industrial nations, the ease of distributing e-books is a considerable advantage. Although they require electricity to be read, the production of e-books does not consume the paper, ink, and other resources that are used to produce print books.

### SUMMARY

It is therefore an aspect of the present disclosure to provide a system for providing an electronic book.

In accordance with an embodiment of the present disclosure, the system comprises an analyzing unit, a regulating unit and a first transmitting unit. The analyzing unit can analyze the electronic book when a reader requests to download the electronic book, and determine whether the electronic book is compatible for the reader according to specification of the reader. The regulating unit can regulate a format of the electronic book in accordance with the specification of the reader when the electronic book is not compatible with the reader when it's determined that the electronic book is incompatible with the reader, to make the electronic book compatible with the reader. The first transmitting unit can transmit the electronic book to the reader after the format of the electronic book conforms with the specification of the reader.

It is another aspect of the present disclosure to provide a method for providing electronic book.

In accordance with another embodiment of the method comprise steps as follows.

(a) The electronic book is analyzed when a reader requests to download the electronic book, and whether the electronic book is compatible with a reader is determined according to a specification of the reader;

(b) When it's determined that the electronic book is incompatible with the reader, a format of the electronic book is regulated in accordance with the specification of the reader to make the electronic book compatible with the reader; and

(c) The regulated electronic book is transmitted to the reader.

It is to be understood that both the foregoing general description and the following detailed description are by examples, and are intended to provide further explanation of the disclosure as claimed.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 is a block diagram of a system in accordance with an embodiment of the present disclosure; and

FIG. 2 is a flow chart of a method in accordance with another embodiment of the present disclosure.

### DESCRIPTION OF THE PREFERRED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

In practice, readers are different. Each reader has its own hardware and software specifications. Therefore, each reader may support specific formats of the electronic book. If a user downloaded an incompatible electronic book for the reader, the reader may not be able to open the electronic book. Furthermore, Web servers can provide certain electronic books, the color scheme of these electronic books is usually polychrome, however, and many readers can only support electronic books that are gray. Thus, if one electronic book with polychrome is downloaded, the reader not only wastes a lot of storage capability to store the electronic book, but also wastes time to decode when opening or exchanging page of the electronic book.

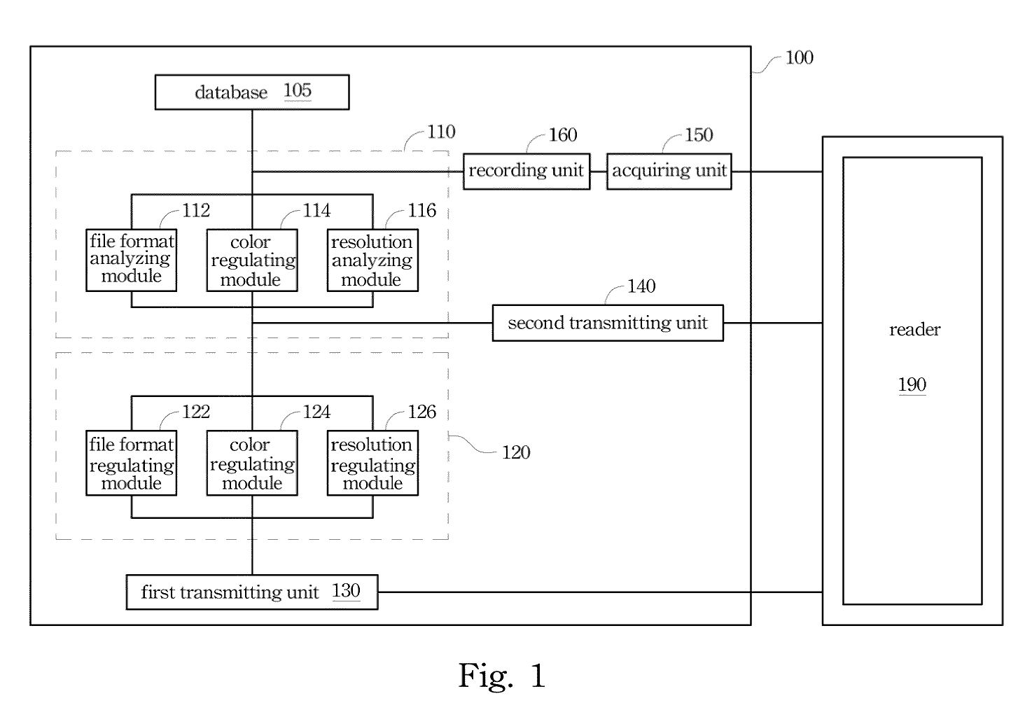

Accordingly, one aspect of the present disclosure is a system for an electronic book. The system may be easily inserted into existing server, and may be applicable or readily adaptable to all technology nodes. The system as discussed below with reference to FIG. 1.

Please refer to FIG. 1. FIG. 1 is a block diagram of a system in accordance with an embodiment of the present disclosure. In FIG. 1, the system 100 comprises a database 105, an analyzing unit 110, a regulating unit 120 and a first transmitting unit 130. The database 105 can store at least one electronic book. The analyzing unit 110 can analyze the electronic book when a reader 190 requests to download the electronic book, and determine whether the electronic book is compatible for the reader 190 according to specification of the reader 190. The regulating unit 120 can regulate a format of the electronic book in accordance with the specification of the reader 190 when the electronic book is not compatible with the reader 190 when it's determined that the electronic book is incompatible with the reader, to make the electronic book compatible with the reader 190. The first transmitting unit 130 can transmit the electronic book to the reader 190 after the format of the electronic book conforms with the specification of the reader 190.

Thus, the system 100 can adjust the format of the electronic book in accordance with the specification of the reader 190 and thereby make the electronic book compatible with the reader 190. The format of the electronic book may be file format, color scheme, resolution, combinations thereof, or the like. The specification of the reader 190, such as support of format, screen size, support of color, or the like may be used. Therefore, the system 100 can provide a compatible electronic book that runs compatibly with the reader 190.

For example, the system 100 may be a Web server, so as to provide the electronic book for the reader 190. One of ordinary skill in the art will appreciate that the above examples are provided for illustrative purposes only to further explain applications of the present invention and are not meant to limit the present invention in any manner. Other network device may be used as appropriate for a given application.

In this embodiment, the reader 190 is an e-book device, sometimes also called an e-book reader. Alternatively, the reader 190 may be an e-paper device, a cellular phone or the like.

In FIG. 1, the system 100 may further comprise a second transmitting unit 140. In the embodiment, the second transmitting unit 140 can transmit the electronic book to the reader 190 when it's determined by the analyzing unit 110 that the electronic book is compatible with the reader 190. Thus, the system 100 can directly provide a compatible electronic book to the reader 190 if the system 100 preloaded the compatible electronic book.

In FIG. 1, the system 100 may further comprise, an acquiring unit 150 and a recording unit 160. The acquiring unit 150 can acquire specification data from the reader 190. The recording unit 160 can record the specification of the reader 190 according to the specification data.

Thus, the system 100 can get the specification of the reader 190, such as brand, model, screen size, storage capacity, supported colors, supported formats or the like. For example, the acquiring unit 150 can acquire specification data from the reader 190 when the reader 190 logs into the system 100, and then the recording unit 160 can record the specification of the reader 190 in accordance with the specification data.

The database 105, the analyzing unit 110, the regulating unit 120 and the first transmitting unit 130, the second transmitting unit 140, the acquiring unit 150, the recording unit 160 and the embodiments thereof may be software and/or hardware; the use of hardware or software is generally (but not always, in that in certain contexts the choice between hardware and software can become significant) a design choice representing cost vs. efficiency tradeoffs.

For a more complete understanding of the analyzing unit 110 and the regulating unit 120, and the advantages thereof, please continue to refer to FIG. 1. In FIG. 1, the analyzing unit 110 may comprise a file format analyzing module 112, and the regulating unit 120 may comprise a file format regulating module 122. The file format analyzing module 112 can analyze a file format of the electronic book when the reader 190 requests to download the electronic book, and determine whether the reader 190 is capable of supporting the file format of the electronic book according to the specification of the reader 190. The file format regulating module 122 can regulate the file format of the electronic book in accordance with the specification of the reader 190 when it's determined by the file format analyzing module 112 that the reader 190 is incapable of supporting the file format of the electronic book, to make the file format of the electronic book correspond with the specification of the reader 190. Furthermore, the second transmitting unit 140 can transmit the electronic book to the reader 190 when it's determined by the file format analyzing module 112 that the reader 190 is capable of supporting the file format of the electronic book.

For example, the database 105 of the system 100 may store an electronic book, in which the title of the electronic book is “The Art of War” and the file format of the electronic book is .PDF files. However, the reader 190 can only support the electronic books that are .txt files. Therefore, the system 100 can transform the file format of the electronic book “The Art of War” from .PDF files into .txt files and then transmit the electronic book to the reader 190 when the reader 190 requests to download the electronic book “The Art of War”.

Additionally or alternatively, the analyzing unit 110 may comprise a color analyzing module 114 and the regulating unit 120 may comprise a color regulating module 124. The color analyzing module 114 can analyze a color scheme of the electronic book when the reader 190 requests to download the electronic book, and determine whether the reader 190 is capable of supporting the color scheme of the electronic book according to the specification of the reader 190. The color regulating module 124 can regulate the color scheme of the electronic book in accordance with the specification of the reader 190 when it's determined by the color analyzing module 114 that the reader 190 is incapable of supporting the color scheme of the electronic book, to make the color scheme of the electronic book correspond with the specification of the reader 190. Furthermore, the second transmitting unit 140 can transmit the electronic book to the reader 190 when it's determined by the color analyzing module 114 that the reader 190 is capable of supporting the color scheme of the electronic book.

For example, the database 105 of the system 100 may store an electronic book, in which the title of the electronic book is “The Art of War” and the color scheme of the electronic book is polychrome. However, the reader 190 can only support the gray scale electronic books. Therefore, the system 100 can transform the color scheme of the electronic book “The Art of War” from polychrome into gray scale and then transmit the electronic book to the reader 190 when the reader 190 requests to download the electronic book “The Art of War”.

Additionally or alternatively, the analyzing unit 110 may comprise a resolution analyzing module 116 and the regulating unit 120 may comprise a resolution regulating module 126. The resolution analyzing module 116 can analyze a resolution of the electronic book when the reader 190 requests to download the electronic book, and determine whether the reader 190 is capable of supporting the resolution of the electronic book according to the specification of the reader 190. The resolution regulating module 126 can regulate the resolution of the electronic book in accordance with the specification of the reader when it's determined by the resolution analyzing module 116 that the reader is incapable of supporting the resolution of the electronic book, to make the resolution of the electronic book correspond with the specification of the reader 190. Furthermore, the second transmitting unit 140 can transmit the electronic book to the reader 190 when it's determined by the resolution analyzing module 116 that the reader is capable of supporting the resolution of the electronic book.

For example, the database 105 of the system 100 may store an electronic book, in which the title of the electronic book is “The Art of War” and the resolution of the electronic book is 1024×768. However, the reader 190 can only support books with 800×600 the resolutions. Therefore, the system 100 can transform the resolution of the electronic book “The Art of War” from 1024×768 into 800×600 and then transmit the electronic book to the reader 190 when the reader 190 requests to download the electronic book “The Art of War”.

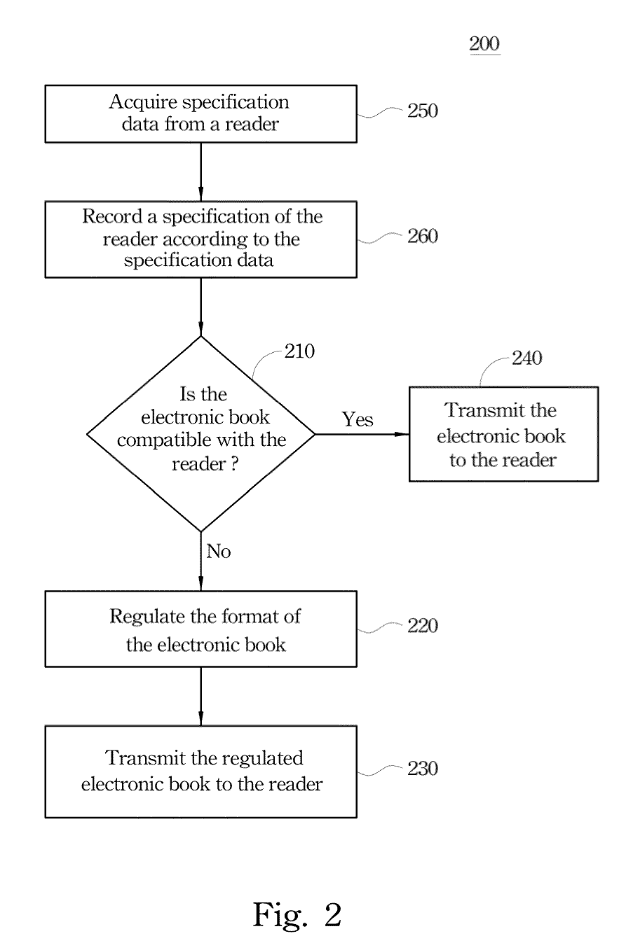

Another aspect of the present disclosure is a method for providing at least one electronic book. The method may be easily inserted into existing server, and may be applicable or readily adaptable to all technology nodes. The method as discussed below with reference to FIG. 2.

Please refer to FIG. 2. FIG. 2 is a flow chart of a method 200 in accordance with another embodiment of the present disclosure. Upon the process of method 200, it should be noted that one step might be performed in series, in parallel, in combination, or otherwise in conjunction with another if the specific order is not described or inferred in the embodiment. Moreover, the apparatuses of performing these steps during the method 200 are disclosed in the preceding embodiment and, thus, are not repeated again. In FIG. 2, the method 200 comprises steps as follows.

In step 210, the electronic book is analyzed when a reader requests to download the electronic book, and whether the electronic book is compatible with a reader is determined according to a specification of the reader In step 220, when it's determined that the electronic book is incompatible with the reader, a format of the electronic book is regulated in accordance with the specification of the reader to make the electronic book compatible with the reader. In step 230, the regulated electronic book is transmitted to the reader.

Thus, the method 200 can adjust the format of the electronic book in accordance with the specification of the reader and thereby make the electronic book compatible with the reader. The format of the electronic book may be file format, color scheme, resolution, combinations thereof, or the like. The specification of the reader, such as support of format, screen size, support of color, or the like may be used. Therefore, the method 200 can provide a compatible electronic book that runs compatibly with the reader.

In FIG. 2, the method 200 may further comprise step 240 during which the electronic book is transmitted to the reader when it's determined that the electronic book is compatible with the reader after step 210. Thus, the method 200 can directly provide a compatible electronic book to the reader if method 200 preloaded the compatible electronic book.

In FIG. 2, the method 200 may further comprise steps as follows. In step 250, specification data is acquired from the reader. In step 260, the specification of the reader is recorded according to the specification data.

Thus; the method 200 can get the specification of the reader, such as brand, model, screen size, storage capacity, support of color, support of format or the like. For example, if the method 200 is applied in a server, the procedure of step 250 can acquire specification data from the reader when the reader login the server, and then the procedure of step 260 can record the specification of the reader in accordance with the specification data.

For a more complete understanding of step 210 and step 220, and the advantages thereof, please continue to refer to FIG. 2. During step 210, a file format of the electronic book is analyzed, and whether the reader is capable of supporting the file format of the electronic book is determined according to specification of the reader. During step 220, the file format of the electronic book is regulated in accordance with the specification of the reader when it's determined that the reader is incapable of supporting the file format of the electronic book, to make the file format of the electronic book correspond with the specification of the reader. Furthermore, the procedure of step 240 is performed to transmit the electronic book to the reader when it's determined in step 210 that the reader is capable of supporting the file format of the electronic book.

For example, the method 200 may be applied in a system including a database that stores an electronic book, in which the title of the electronic book is “The Art of War” and the file format of the electronic book is .PDF files. However, the reader can only support the electronic books that are .txt files. Therefore, the system can transform the file format of the electronic book “The Art of War” from .PDF files into .txt files and then transmit the electronic book to the reader when the reader requests to download the electronic book “The Art of War”.

Please continue to refer to FIG. 2. During step 210, a color scheme of the electronic book is analyzed, and whether the reader is capable of supporting the color scheme of the electronic book is determined according to the specification of the reader. During step 220, the color scheme of the electronic book is regulated in accordance with the specification of the reader when it's determined that the reader is incapable of supporting the color scheme of the electronic book, to make the color scheme of the electronic book correspond with the specification of the reader. Furthermore, the procedure of step 240 is performed to transmit the electronic book to the reader when it's determined in step 210 that the reader is capable of supporting the color scheme of the electronic book.

For example, the method 200 may be applied in a system including a database that stores an electronic book, in which the title of the electronic book is “The Art of War” and the color scheme of the electronic book is polychrome. However, the reader can merely support the gray scale electronic books. Therefore, the system can transform the color scheme of the electronic book “The Art of War” from polychrome into gray scale and then transmit the electronic book to the reader when the reader requests to download the electronic book “The Art of War”.

Please continue to refer to FIG. 2. During step 210, a resolution of the electronic book is analyzed, and whether the reader is capable of supporting the resolution of the electronic book is determined according to the specification of the reader. During step 210, the resolution of the electronic book is regulated in accordance with the specification of the reader when it's determined that the reader is incapable of supporting the resolution of the electronic book, to make the resolution of the electronic book correspond with the specification of the reader. Furthermore, the procedure of step 240 is performed to transmit the electronic book to the reader when it's determined in step 210 that the reader is capable of supporting the resolution of the electronic book.

For example, the method 200 may be applied in a system including a database that stores an electronic book, in which the title of the electronic book is “The Art of War” and the resolution of the electronic book is 1024×768. However, the reader can only support books with 800×600 the resolutions. Therefore, the system can transform the resolution of the electronic book “The Art of War” from 1024×768 into 800×600 and then transmit the electronic book to the reader when the reader requests to download the electronic book “The Art of War”.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for providing at least one electronic book, comprising:
an analyzing unit for analyzing the electronic book when a reader requests to download the electronic book, and determining whether the electronic book is compatible with the reader according to a specification of the reader;
a regulating unit for regulating a format of the electronic book in accordance with the specification of the reader when it's determined that the electronic book is incompatible with the reader, to make the electronic book compatible with the reader; and
a first transmitting unit for transmitting the electronic book to the reader after the format of the electronic book conforms with the specification of the reader.

2. The system as claimed in claim 1, further comprising:
an acquiring unit for acquiring specification data from the reader; and
a recording unit for recording the specification of the reader according to the specification data.

3. The system as claimed in claim 1, wherein the analyzing unit comprises a file format analyzing module for analyzing a file format of the electronic book when the reader requests to download the electronic book, and determining whether the reader is capable of supporting the file format of the electronic book according to the specification of the reader.

4. The system as claimed in claim 3, wherein the regulating unit comprises a file format regulating module for regulating the file format of the electronic book in accordance with the specification of the reader when it's determined by the file format analyzing module that the reader is incapable of supporting the file format of the electronic book, to make the file format of the electronic book correspond with the specification of the reader.

5. The system as claimed in claim 1, wherein the analyzing unit comprises a color analyzing module for analyzing a color scheme of the electronic book when the reader requests to download the electronic book, and determining whether the reader is capable of supporting the color scheme of the electronic book according to the specification of the reader.

6. The system as claimed in claim 5, wherein the regulating unit comprises a color regulating module for regulating the color scheme of the electronic book in accordance with the specification of the reader when it's determined by the color analyzing module that the reader is incapable of supporting the color scheme of the electronic book, to make the color scheme of the electronic book correspond with the specification of the reader.

7. The system as claimed in claim 1, wherein the analyzing unit comprises a resolution analyzing module for analyzing a resolution of the electronic book when the reader requests to download the electronic book, and determining whether the reader is capable of supporting the resolution of the electronic book according to the specification of the reader.

8. The system as claimed in claim 7, wherein the regulating unit comprises a resolution regulating module for regulating the resolution of the electronic book in accordance with the specification of the reader when it's determined by the resolution analyzing module that the reader is incapable of supporting the resolution of the electronic book, to make the resolution of the electronic book correspond with the specification of the reader.

9. The system as claimed in claim 1, further comprising:
a second transmitting unit for transmitting the electronic book to the reader when it's determined by the analyzing unit that the electronic book is compatible with the reader.

10. A method for providing at least one electronic book, which comprises the steps of:
(a) analyzing the electronic book when a reader requests to download the electronic book, and determining whether the electronic book is compatible with the reader according to a specification of the reader;
(b) when it's determined that the electronic book is incompatible with the reader, regulating a format of the electronic book in accordance with the specification of the reader to make the electronic book compatible with the reader; and
(c) transmitting the regulated electronic book to the reader.

11. The method as claimed in claim 10, further comprising:
acquiring specification data from the reader; and
recording the specification of the reader according to the specification data.

12. The method as claimed in claim 10, wherein the step (a) comprises:
analyzing a file format of the electronic book and determining whether the reader is capable of supporting the file format of the electronic book according to specification of the reader.

13. The method as claimed in claim 12, wherein the step (b) comprises:
regulating the file format of the electronic book in accordance with the specification of the reader when it's determined that the reader is incapable of is supporting the file format of the electronic book, to make the file format of the electronic book correspond with the specification of the reader.

14. The method as claimed in claim 10, wherein the step (a) comprises:
analyzing a color scheme of the electronic book and determining whether the reader is capable of supporting the color scheme of the electronic book according to the specification of the reader.

15. The method as claimed in claim 14, wherein the step (b) comprises:
regulating the color scheme of the electronic book in accordance with the specification of the reader when it's determined that the reader is incapable of supporting the color scheme of the electronic book, to make the color scheme of the electronic book correspond with the specification of the reader.

16. The method as claimed in claim 10, wherein the step (a) comprises:
analyzing a resolution of the electronic book and determining whether the reader is capable of supporting the resolution of the electronic book according to the specification of the reader.

17. The method as claimed in claim 14, wherein the step (b) comprises:
regulating the resolution of the electronic book in accordance with the specification of the reader when it's determined that the reader is incapable of supporting the resolution of the electronic book, to make the resolution of the electronic book correspond with the specification of the reader.

18. The method as claimed in claim 10, further comprising after the step (a):
transmitting the electronic book to the reader when it's determined that the electronic book is compatible with the reader.
